(19) United States
(12) Patent Application Publication
(10) Pub. No.: US 2007/0199482 A1
(43) Pub. Date: Aug. 30, 2007

(54) Process For Producing Concrete Material And Apparatus Therefor

(76) Inventors: Kensuke Kanai, Tokyo (JP); Shingo Jami, Tokyo (JP); Akira Ohno, Tokyo (JP)

Correspondence Address: POSZ LAW GROUP, PLC, 12040 SOUTH LAKES DRIVE, SUITE 101, RESTON, VA, 20191, US

(21) Appl. No.: 10/594,701

(22) PCT Filed: Mar. 25, 2005
(86) PCT No.: PCT/JP05/05512

§ 371 Date: Sep. 28, 2006

(30) Foreign Application Priority Data
Mar. 31, 2004 (JP) 2004-102754

(51) Int. Cl. B02C 21/00

(52) U.S. Cl. 106/638; 241/21

(57) ABSTRACT

An object of the present invention is to manufacture a material for concrete by using a fresh concrete sludge as a starting material. The invention relates to a method of manufacturing a material for concrete in which a material for concrete is manufactured from a slurry composed of a fresh concrete sludge obtained by treating a fresh concrete waste to separate a coarse aggregate and a fine aggregate. The manufacturing method comprises a grinding step of obtaining a product containing fine particles with a mean particle size of 10 μm or less by wet grinding the slurry under a condition of water content of 60 wt. % or more.

### FIELD OF THE INVENTION

The present invention relates to a method for manufacturing a concrete material by using a fresh concrete sludge as a starting material and to a manufacturing apparatus therefore.

### BACKGROUND ART OF THE INVENTION

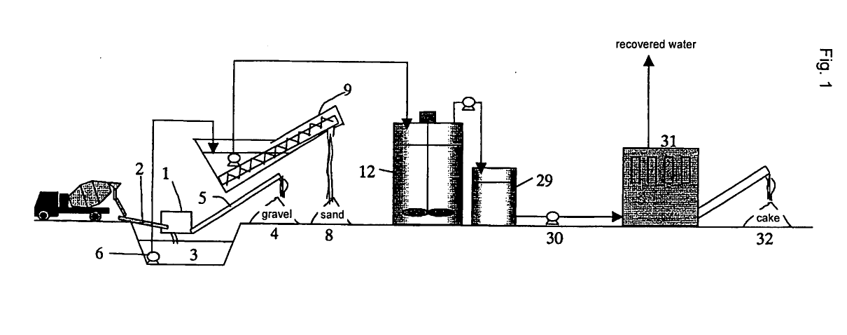

A method for regenerating a sludge of a fresh concrete has been implemented by using an apparatus shown in FIG. 1. After the fresh concrete production apparatus or transportation apparatus has been used, the remaining fresh concrete waste is washed by supplying washing water into those apparatuses. The resultant discharge waster is received in a chute 2 and fed to a trommel 1 where a coarse aggregate is separated. A sludge containing a fine aggregate is sent to a pit 3. The coarse aggregate is recovered with a conveyor 5 to a gravel site 4. The sludge sent to the pit is fed with a concrete pump 6 to a sand classifier 9 where a fine aggregate is separated. The sludge water containing a cement hydrate is sent to a stirring tank 12. The fine aggregate is recovered to a sand site 8. On the other hand, the sludge water containing the cement hydrate is retained for a certain time in a stirring tank 12 equipped with a stirring mechanism, while consolidation thereof is being prevented by stirring. The amount of the cement hydrate that will be treated in the next stage is guided to a settling and sedimentation tank 29. The sludge water that settled therein is pumped by a high-pressure pump 30 into a filter press 31 and dewatered. The supernatant water is recovered and a filtration cake is formed. The obtained filtration cake is stored in a cake site 32. The coarse aggregate and fine aggregate recovered by the above-described method are reused for manufacturing a fresh concrete, and the supernatant water of the sludge is reused as mixing water for fresh concrete or washing water for apparatuses. However, the larger part of the sludge case is naturally dried, consolidated, and landfill disposed as an industrial case.

On the other hand, calcium silicate hydrates with a specific Ca/Si molar ratio and having a specific ignition loss are known as concrete materials effective for bleeding reduction (Japanese Patents No. 2881401 and 2967809).

The amount of fresh concrete sludge (dewatered after settling) generated annually in Japan is considered to be about 2,000,000 m³. Furthermore, the fresh concrete sludge that is defined as “sludge” in the waste treatment process requires landfill processing in controlled type landfill sites with a very high treatment cost and places a huge load on fresh concrete manufacturers.

On the other hand, the present state of waste treatment fields, especially in urban areas, is such that sites are difficult to reserve and the treatment cost tends to increase from year to year.

With the foregoing in view, the effective use of fresh concrete sludge would make it possible to alleviate or resolve the above-described problems.

### DISCLOSURE OF THE INVENTION

Accordingly, it is an object of the present invention to manufacture a material for concrete using a fresh concrete sludge as a starting material.

The results of a comprehensive study conducted by the inventors demonstrated that the above-described object can be attained by employing a specific process. This finding led to the creation of the present invention.

Thus, the present invention relates to the below-described method for manufacturing a material for concrete and a manufacturing apparatus therefore.

1. A method for manufacturing a concrete material from a slurry containing a fresh concrete sludge, the method comprising at least
a grinding step of obtaining a product containing fine particles having a mean particle diameter of 10 μm or less by wet grinding the slurry under a condition of water content of 60 wt. % or more.

2. The manufacturing method according to above 1, wherein the water content is from 60 to 95 wt. %.

3. The manufacturing method according to above 1, wherein the fine particles have a mean particle diameter of 1 μm or more but less than 10 μm.

4. The manufacturing method according to above 1, the method further comprising, prior to the grinding step, a water content adjustment step of adjusting the water content of the slurry by taking out and dewatering part of the slurry and returning the dewatered remaining fraction into the slurry.

5. The manufacturing method according to above 1, wherein the slurry is obtained by a method comprising
(1) a coarse aggregate separation step of separating a coarse aggregate from a fresh concrete waste;
(2) a fine aggregate separation step of separating a fine aggregate from the slurry obtained in the coarse aggregate separation step; and
(3) a fine aggregate very fine fraction separation step of separating a very fine fraction of the fine aggregate from the slurry obtained in the fine aggregate separation step.

6. A concrete material obtained by the manufacturing method according to above 1.

7. A grout material containing cement and the concrete material according to above 6.

8. An apparatus for manufacturing a concrete material from a fresh concrete sludge, comprising:
(1) coarse aggregate separation means for separating a coarse aggregate from a fresh concrete waste;
(2) fine aggregate separation means for separating a fine aggregate from the slurry obtained by performing the coarse aggregate separation treatment;
(3) water content adjustment means for adjusting a water content of the slurry by taking out and dewatering part of the slurry obtained by implementing the separation treatment of the coarse aggregate and fine aggregate, and returning the dewatered remaining fraction into the slurry; and
(4) grinding means for wet grinding the slurry with the water content thereof adjusted in the water content adjustment means.

9. The manufacturing apparatus according to above 8, further comprising fine aggregate very fine fraction separation means for separating a very fine fraction of the fine aggregate from the slurry obtained in the fine aggregate separation means.

### ADVANTAGES OF THE INVNETION

According to the manufacturing method and manufacturing apparatus in accordance with the present invention, a fresh concrete sludge is wet ground by the predetermined method, whereby a material suitable of concrete can be obtained. In particular, in the material obtained in accordance with the present invention, bleeding of the slurry comprising cement is effectively inhibited. Therefore, the material can be advantageously used for a cement filling material such as grout.

Furthermore, with the manufacturing method and manufacturing apparatus in accordance with the present invention, the fresh concrete sludge that has been conventionally discarded as waste can be effectively reused, whereby a contribution is made to effective utilization of resources and preservation of environment.

### BRIEF DESCRIPTION OF THE INVENTION

FIG. 1 illustrates schematically a conventional apparatus for treating fresh concrete;

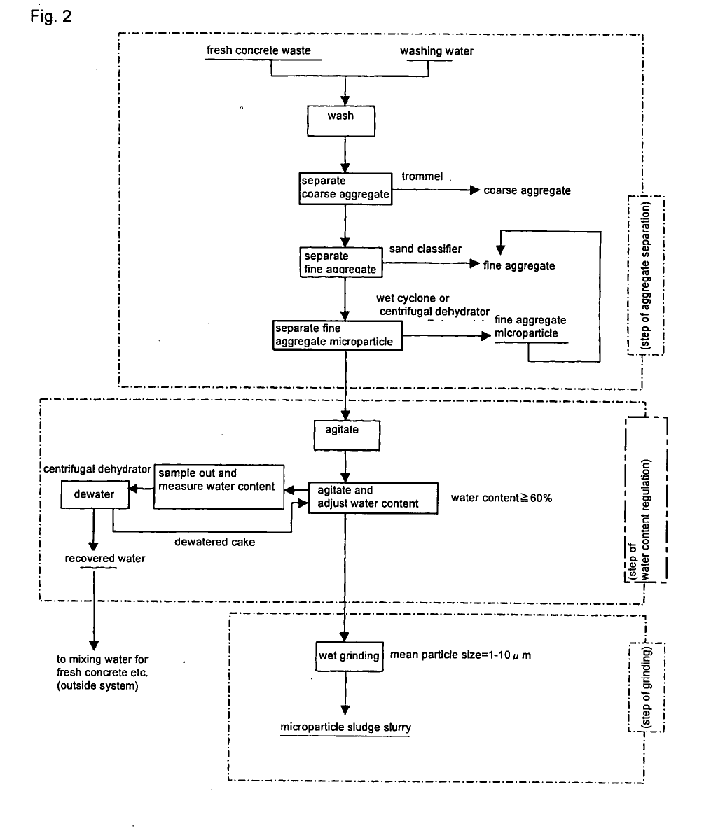

FIG. 2 is a flowchart illustrating an example of the manufacturing method in accordance with the present invention; and

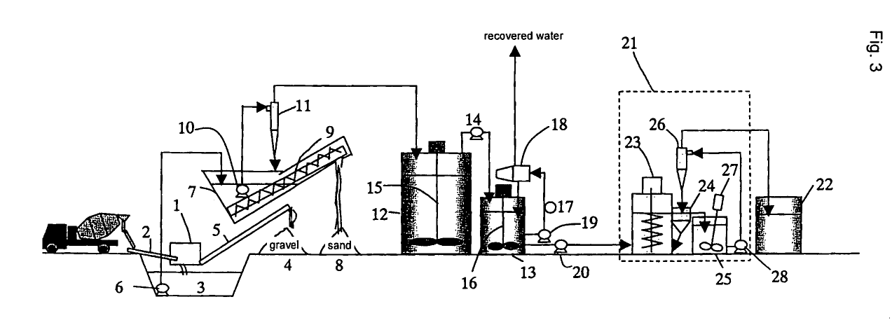

FIG. 3 illustrates schematically the manufacturing apparatus in accordance with the present invention.

1 trommel
2 chute
3 pit
4 gravel site
5 conveyor
6 concrete pomp
7 hopper
8 sand site
9 sand classifier
10 slurry pump
11 wet cyclone
12 stirring tank
13 water content adjustment tank
14 slurry pump
15 agitator
16 agitator
17 hygrometer
18 centrifugal dewatering apparatus
19 slurry pump
20 slurry pump
21 grinding apparatus
22 product tank
23 tower mill
24 sedimentation tank
25 maturing tank
26 wet cyclone
27 agitator
28 slurry pump
29 sedimentation tank
30 high pressure pump
31 filter press
32 cake site

### BEST MODE FOR CARRYING OUT THE INVENTION

1. Method for Manufacturing a Concrete Material

The method for manufacturing a material for concrete in accordance with the present invention is a method for manufacturing a concrete material from a slurry containing a fresh concrete sludge, the method comprising at least
a grinding step of obtaining a product containing fine particles having a mean particle diameter of 10 μm or less by wet grinding the slurry under a condition of water content of 60 wt. % or more.
   (1) Preparation of Slurry

A slurry comprising a fresh concrete sludge obtained by carrying out a separation processing of a coarse aggregate and a fine aggregate with respect to a fresh concrete waste can be used as the aforementioned slurry. Here, the recovered coarse aggregate and fine aggregate can be reused.

No specific limitation is placed on the fresh concrete waste, and a waste can be used that was discarded in the production of concretes of various types for structures such as homes and buildings and engineering structures such as roads and bridges.

A sludge waste water originating when, for example, fresh concrete production equipment, transportation apparatus, and containers (for example, inside an agitator in an agitator car and fresh concrete accommodation units of fresh concrete mixer apparatuses and stirring machines) are washed with water can be also used as is. Furthermore, a cake substance obtained by removing water from such sludge waste water can be also used as the slurry material.

No specific limitation is placed on the content of solids in the slurry, and a slurry with any content of solids can be used.

The separation treatment of coarse aggregate and fine aggregative can be implemented by removing and recovering the coarse aggregate and fine aggregate by a well-known method. For example, it can be implemented by using an appropriate combination of the well-known apparatuses such as a trommel and a sand classifier. The especially preferred separation method is described in the “Aggregate separation step” hereinbelow.

Furthermore, a certain amount of coarse aggregate or fine aggregate may remain in the slurry after the separation treatment, provided that the advantages of the present invention is not adversely affected.

If necessary, part of the slurry can be reused as a fresh concrete starting material. In this case, if necessary, the water content can be appropriately adjusted.

The slurry obtained in the above-described manner is supplied to a grinding step under a condition that the water content thereof is eventually 60 wt. % or more, preferably from 60 to 95 wt. %.

When the water content is adjusted, the adjustment can be carried out by using a well-known apparatus such as a setting and sedimentation tank, a centrifugal dewatering apparatus, and a wet cyclone. The especially preferred water content adjustment method is described in the “Water content adjustment step” hereinbelow.

<Aggregate Separation Step>

In the slurry preparation process, the following aggregate separation step is preferably performed. Thus, a slurry comprising the fresh concrete sludge can be advantageously obtained by using a method comprising a coarse aggregate separation step of separating a coarse aggregate from a fresh concrete waste, a fine aggregate separation step of separating a fine aggregate from the slurry obtained in the coarse aggregate separation step, and a fine aggregate very fine fraction separation step of separating a very fine fraction of the fine aggregate from the slurry obtained in the fine aggregate separation step.

The preferred embodiment is shown in FIG. 2. In the coarse aggregate separation step, a coarse aggregate is separated from a fresh concrete waste. The separation of the coarse aggregate is carried out by using a trommel. The separated coarse aggregate is recovered with a conveyor to a gravel site, and the remaining slurry is sent to a fine aggregate separation step. In the fine aggregate separation step, a fine aggregate is separated from the slurry obtained in the coarse aggregate separation step. The separation of the fine aggregate is carried out by using a sand classifier. The separated fine aggregate is recovered to a sand site, and the remaining slurry is sent to a fine aggregate very fine fraction separation step. In the fine aggregate very fine fraction separation step, a very fine fraction of the fine aggregate is separated from the slurry obtained in the fine aggregate separation step. Here, the very fine fraction of the fine aggregate means sand-derived particles that could not be separated in the fine aggregate separation step, and the particle size thereof is about from 0.05 to 2 mm. The components thereof are quartz, feldspar, calcium carbonate, and the like. The separation of the very fine fraction of the fine aggregate is carried out with a wet cyclone. The separated fine aggregate is recovered with a conveyor to a sand site, and the remaining slurry is used for manufacturing a material for concrete. The slurry obtained via the above-described aggregate separation process is fed for storage to a stirring layer.

<Water Content Adjustment Step>

The following water content adjustment process is preferably employed when the slurry is prepared. With this method, the water content can be adjusted more advantageously. Thus, in the preferred water content adjustment process, the water content of the slurry is adjusted by taking out and dewatering part of the slurry prior to the grinding process, and returning the fraction remaining after the dewatering into the slurry.

The preferred embodiment is shown in FIG. 2. First, the slurry that has been temporarily retained in the stirring layer under stirring performed to prevent the slurry from consolidation is fed to a water content adjustment layer. Part of the slurry present in the water content adjustment layer is taken out and the water content is measured. The slurry is then dewatered and the fraction remaining after the dewatering (dewatered cake) is returned into the water content adjustment layer. The separation water generated by the dewatering is discharged as a recovered water to the outside of the system and reused as a mixing water for fresh concrete or for other applications. Here, the intensity of the dewatering treatment is increased or decreased based on the measured value of water content, and the water content of the slurry contained in the water content adjustment layer is adjusted to the target value. A centrifugal dewatering apparatus can be used for the dewatering treatment and the adjustment of water content can be carried out by performing a simple control, for example such that “when the water content is higher than the target, the dewatering treatment is performed, and when the water content is lower than the target, the dewatering treatment is stopped”. The slurry obtained via the above-described water content adjustment process is fed to a grinding step.

(2) Grinding Step

In the grinding step, a product comprising fine particles with a mean particle size of 10 μm or less is obtained by wet grinding the slurry under a condition of water content of 60 wt. % or more.

In accordance with the present invention, when wet grinding is performed, the water content of the slurry is adjusted to 60 wt. % or more (preferably 60 to 95 wt. %). The problem arising when the water content is less than 60 wt. % is that the grinding efficiency is decreased.

In accordance with the present invention, when the slurry as a starting material has the water content of 60 wt. % or higher, wet grinding can be conducted without performing the adjustment of water content. On the other hand, when the water content of the slurry is less than 60 wt. %, the water content can be adjusted by adding water. Furthermore, in accordance with the present invention, the adjustment to the appropriate water content can be also performed by removing part of the water from the slurry. In this case, dewatering can be conducted by settling or by using a well-known apparatus such as a wet cyclone or a centrifugal dewatering apparatus.

The wet grinding can be implemented by the conventional method. For example, the wet grinding can be performed by using a well-known grinding apparatus such as a tower mill, an attritor, a vibration mill, a medium stirring mill, and a ball mill. The wet grinding may be conducted till the solid fraction assumes a form of fine particles with a mean particle size of 10 μm or less (preferably, 1 μm or more to less than 10 μm, and more preferably from 2 μm to 8 μm). By producing such fine particles, a material with even better properties can be obtained. Therefore, the grinding conditions can be set appropriately within the range of well-known conditions so as to obtain the above-described particle size.

2. Apparatus for Manufacturing a Concrete Material

The manufacturing apparatus in accordance with the present invention is advantageous for implementing the manufacturing method in accordance with the present invention. An example of such apparatus is described above.

The manufacturing apparatus in accordance with the present invention is an apparatus for manufacturing a concrete material from a fresh concrete sludge, this apparatus comprising:

(1) coarse aggregate separation means for separating a coarse aggregate from a fresh concrete waste;

(2) fine aggregate separation means for separating a fine aggregate from the slurry obtained by performing the coarse aggregate separation treatment;

(3) water content adjustment means for adjusting a water content of the slurry by sampling and dewatering part of the slurry obtained by implementing the separation treatment of the coarse aggregate and fine aggregate and returning the dewatered remaining fraction into the slurry; and

(4) grinding means for wet grinding the slurry with the water content adjusted in the water content adjustment means.

In a more preferred mode, the apparatus further comprises fine aggregate very fine fraction separation means for separating a very fine fraction of the fine aggregate from the slurry obtained in the fine aggregate separation means.

Each means can be appropriately composed from respective well-known apparatuses or components. The preferred embodiment of the apparatus in accordance with the present invention is shown in FIG. 3. This apparatus has coarse aggregate separation means, fine aggregate separation means, fine aggregate very fine fraction separation means, water content adjustment means, and grinding means. The means are sequentially connected by conveying machines or conveying piping.

The coarse aggregate separation means comprises a chute 2 for receiving a ready-mix concrete waste having washing water mixed therewith, and supplying this waste to a trommel 1, the trommel 1 for separating a coarse aggregate, a pit 3 for receiving the slurry from which the coarse aggregate has been separated, and a belt conveyor 5 for conveying the separated coarse aggregate to a gravel site 4. The pit is connected to the fine aggregate separation means by a pipe (not shown in the figure) via a slurry pump 6.

The fine aggregate separation means is a sand classifier which comprises a hopper 7 for retaining a slurry that is the separation object, a screw conveyor 9 tilted upward from the hopper bottom and serving to discharge the precipitated sand to a sand site 8, and a slurry pump 10 for discharging the supernatant water present in the hopper. The fine aggregate separation means is connected to the fine aggregate very fine fraction separation means by a pipe via a slurry pump 10.

The fine aggregate very fine fraction separation means comprises a wet cyclone 11. The drop port of the wet cyclone is connected to the hopper 7 of the sand classifier with a chute (not shown in the figure) for returning the very fine fraction of the fine aggregate. The slurry outlet port of the wet cyclone is connected by a pipe to water content adjustment means.

The water content adjustment means comprises a stirring tank 12 and a water content adjustment tank 13. In order to transport the slurry from the stirring tank 12 into the water content adjustment tank 13, the two are connected by a pipe via a slurry pump 14. The stirring tank comprises a tank body having a capacity necessary to retain temporarily the slurry and a stirring mechanism 15 for preventing the slurry from consolidating inside the tank. The water content adjustment tank comprises a tank body 13, an agitator 16 for homogenizing the slurry in the tank, a hygrometer 17 for measuring the water content of the slurry in the tank, and a centrifugal dewatering apparatus 18. The tank body is connected to the inlet port of the centrifugal dewatering apparatus 18 by a pipe via a slurry pump 19, and the hygrometer 17 is disposed in a pipe connecting the tank body and the inlet port of the centrifugal dewatering apparatus. The remainder outlet port of the centrifugal dewatering apparatus is connected to the tank body via a chute (not shown in the figure), and a pipe for transferring the recovered water out of the system is connected to the recovered water outlet port of the centrifugal dewatering apparatus. Furthermore, the tank body is connected to the grinding means by a pipe via the slurry pump 20.

The grinding means comprises a grinding apparatus 21 and a product tank 22, the two being connected by a pipe for transporting the slurry from the grinding apparatus to the product tank. The grinding apparatus comprises a tower mill 23, a sedimentation tank 24 for receiving the slurry that overflowed from the tower mill and conducting primary classification by sedimentation, a maturing tank 25 for receiving the slurry discharged from the sedimentation tank and maturing till a hydration reaction of the unreacted cement fraction contained in slurry is accelerated, and a wet cyclone 26 for secondary classification of the slurry. The lower part of the sedimentation tank is connected to the tower mill 23. The maturing tank 25 comprises a stirring mechanism 27 for preventing consolidation. Furthermore, the maturing tank 25 is connected to the wet cyclone 26 by a pipe via a slurry pump 28. The drop port of the wet cyclone is connected to the sedimentation tank 24 with a chute (not shown in the figure) for returning the remaining fraction after classification to the sedimentation tank. The slurry outlet port of the wet cyclone is connected by a pipe to the product tank 22.

The apparatus in accordance with the present invention is not limited to that shown in FIG. 3, and a variety of design changes can be made within the scope of the object of performing the method in accordance with the present invention can still be attained.

The examples of design modification of the manufacturing apparatus shown in FIG. 3 are presented below in clauses (1) to (4), and they can be employed individually, or in combinations of two or more thereof.

(1) The fine aggregate very fine fraction separation means is omitted and the fine aggregate separation means and water content adjustment means are directly connected to each other.

(2) The configuration of the grinding apparatus in the grinding means is changed from that based on a tower mill to that based on an attritor, a vibration mill, a medium stirring mill, a ball mill, or other well-known grinding mechanism.

(3) In the water content adjustment means, a control unit is additionally provided to control the operation of the centrifugal dewatering apparatus based on the output signal of the hygrometer.

(4) The transportation mechanism connecting the aforementioned means or apparatuses constituting those means is changed to a well-known transportation machine such as a slurry pump, piping, a pipe conveyor, a belt conveyor, a screw conveyor, a chain conveyor, and a bucket conveyor according to the arrangement of the apparatuses or other factors.

3. Concrete Material

The present invention also includes a concrete material obtained by the manufacturing method in accordance with the present invention. As described hereinabove, the material for concrete in accordance with the present invention is in the form of fine particles with a mean particle diameter of 10 μm or less (preferably 1 μm or more to less than 10 μm, and more preferably 2 μm or more to 8 μm or less). This material can be used as is, or in a mixture with of other materials it can be used for concrete materials of various types (fillers such as grout materials and the like).

For example, a grout material can be obtained by mixing with cement. More specifically, a composition comprising a blast furnace slag cement, the material of the present invention, and water and having a weight ratio of the blast furnace slag cement and solid fraction in the material in accordance with the present invention of about 1:0.24 to 0.6 can be advantageously used as a grout material (filler). If necessary, additives, that have been compounded with the conventional grout materials (for example, solidification retardants such as sodium glucolate and saccharides such as sucrose, expansion agents such as aluminum dust, and other concrete additive agents) can be contained in the grout material. According to the grout material of the present invention, bleeding is effectively inhibited, and the grout material has good viscosity. Accordingly, this grout material can demonstrate properties superior to those obtained with the conventional grout materials.

### EXAMPLES

The examples and comparative examples are described below to clarify further the specific features of the present invention. However, the scope of the present invention is not limited to those examples.

### Example 1

A material for concrete was manufactured by using the apparatus shown in FIG. 3.

A fresh concrete waste comprising washing water and discharged from the agitator car that returned from the site was used as the starting material.

The grinding conditions are described below.

1) Tower mill: manufactured by Kubota KK, model KW-5W.

2) Medium: high-chromium balls with a diameter of 2 mm (1000 kg).

3) Screw revolution rate: 4 m/sec.

4) Water content: 87.5 wt. %.

5) Retention time in tower mill: 20 min.

### Example 2

In the apparatus shown in FIG. 3, a material for concrete was manufactured in the same manner as in Example 1, except that a bypass pipe was provided between the fine aggregate separation means and water content adjustment means and the fine aggregate very fine fraction separation means was not employed.

### Comparative Example 1

In the apparatus shown in FIG. 3, a concrete material was manufactured in the same manner as in Example 1, except that a branch pipe was provided in the water content adjustment layer, the grinding means was not employed, and the slurry after water content adjustment was used as is as the concrete material.

### Comparative Example 2

Commercial fly ash balloons (product name CF Beads, manufactured by Union Chemical Co., Ltd.) was used as a concrete material.

### Comparative Example 3

Commercial bentonite (product name Akagi-jirushi, manufactured by Hojun Corp.) was used as a concrete material.

### Test Example 1

Chemical analysis values of the products obtained in Examples 1 to 2 and Comparative Example 1 and also 50% particle size and specific gravity of the products obtained in the examples and comparative examples were measured. The results are shown in Table 1 (chemical analysis values) and Table 2 (50% particle size and specific gravity).

TABLE 1
Chemical analysis values

| | ig. | | | | | | | | | | |
|---|---|---|---|---|---|---|---|---|---|---|---|
| | loss | insol | SiO₂ | Al₂O₃ | Fe₂O₃ | CaO | MgO | SO₃ | Na₂O | K₂O | Total |
| Example 1 | 16.30 | 13.88 | 17.47 | 6.19 | 2.50 | 39.60 | 2.02 | 1.14 | 0.09 | 0.14 | 99.6 |
| Example 2 | 23.79 | 5.01 | 16.22 | 4.61 | 2.75 | 41.49 | 1.84 | 3.69 | 0.08 | 0.13 | 99.6 |
| Comparative | 23.79 | 5.01 | 16.22 | 4.61 | 2.75 | 41.49 | 1.84 | 3.69 | 0.08 | 0.13 | 99.6 |
| Example 1 | | | | | | | | | | | |

*When the starting material was the same, the same chemical analysis values were obtained regardless of grinding.

TABLE 2
Physical values

| | | Specific gravity |
|---|---|---|
| | 50% particle size (μm) | (−) |
| Example 1 | 12.56 | 2.55 |
| Example 2 | 5.22 | 2.40 |
| Comparative Example 1 | 12.56 | 2.40 |
| Comparative Example 2 | 63.3 | 0.58 |
| Comparative Example 3 | 18.52 | 2.32 |

The physical properties were measured in the following manner.

Chemical analysis values: measurements were conducted according to JIS R5202.

50% Particle size: measurements were conducted by using a device for measuring particle size distribution of a laser diffraction and scattering type (product name Microtrack SRA, manufactured by Nikkiso KK) and using methanol as a solvent.

Specific gravity: a slurry was sealed in an air-tight state in an air-tight container made from an acrylic resin and having a capacity of 10 cm³ in a thermostat at 20° C. and a true specific gravity was measured from the volume and weight of the slurry.

### Test Example 2

Using the products of Examples 1 to 2 and Comparative Examples 1 to 2, grout materials for sewerage facility patching were prepared with compositions shown in Table 3, and a bleeding ratio and a flow value were measured for each grout material. The results are shown in Table 4.

The bleeding ratio was measured according to the standard JSCE-F522 of the Japan Society of Civil Engineers “Test Method for Bleeding Ratio and Expansion Ratio of Injection Mortar of Pre-packed Concrete (Polyethylene Bag method)”. Furthermore, the flow value was measured according to JIS R5201, and the draw flow was measured on a glass plate.

TABLE 3
Compositions of grout materials for sewerage facility patching

| | | | Fresh | Very finely | | | |
|---|---|---|---|---|---|---|---|
| | | | concrete | ground | | | |
| | | | sludge | sludge | | | |
| | Blast | | (amount of | (amount of | | | |
| | furnace | | solid | solid | | Adhesive | |
| | slag B | | fraction is | fraction is | | of polymer | |
| | type | Fly ash | shown in | shown in | | dispersion | |
| | cement | balloon | parentheses) | parentheses) | Water | system | Water/powder |
| | (kg/m³) | (kg/m³) | (kg/m³) | (kg/m³) | (kg/m³) | (kg/m³) | ratio |
| Example 1 | 750 | — | — | 796 (100) | — | 17 | 0.82 |
| Example 2 | 750 | — | — | 480 (60) | 291 | 17 | 0.88 |
| Comparative | 750 | — | 796 (100) | — | — | 17 | 0.82 |
| Example 1 | | | | | | | |
| Comparative | 750 | 200 | — | — | 372 | 17 | 0.39 |
| Example 2 | | | | | | | |

*Water content of fresh concrete: 87.5%

TABLE 4
Evaluation results for grout materials for sewerage facility patching

| | Bleeding ratio | Flow value |
|---|---|---|
| | after 24 h (%) | (mm) |
| Example 1 | 0 | 330 |
| Example 2 | 0 | 330 |
| Comparative Example 1 | 30 | 390 |
| Comparative Example 2 | 0 | 225 |

As follows from the results shown in Table 4, because the particle size in Comparative Example 1 was larger, the bleeding ratio assumed a very high value. In Comparative Example 2, though the bleeding ratio was satisfactory, the flow value was low and pumping efficiency over a long distance degraded. In contrast, the products of Examples 1 and 2 had a low bleeding ration (standard value 0%) and the flow value thereof also assumed a normal value (standard value <270 mm).

### Test Example 3

Products prepared in Examples 1 to 2, Comparative Example 1 and Comparative Example 3 were used, liquids A for backfill pouring in shield tunneling operations were prepared according to the formulation in Table 5, and the bleeding ratio and viscosity thereof were measured. The results are shown in Table 6.

The bleeding ratio was measured by introducing the liquid A in an amount of 1 dm³ into a measurement cylinder with a capacity of 1 dm³ and conducting measurement in the same manner as in Test Example 2. The viscosity was measured at a temperature of 20° C. with a rotary viscometer.

TABLE 5
Compositions of liquids A for backfill pouring in shield
tunneling operations

| | | | Fresh | | | |
|---|---|---|---|---|---|---|
| | | | concrete | | | |
| | | | sludge | Very finely | | |
| | | | (amount of | ground sludge | | |
| | Blast | | solid | (amount of | | |
| | furnace slag | | fraction is | solid fraction | | |
| | B type | Fly ash | shown in | is shown in | | |
| | cement | balloon | parentheses) | parentheses) | Water | Water/powder |
| | (kg/m³) | (kg/m³) | (kg/m³) | (kg/m³) | (kg/m³) | ratio |
| Example 1 | 250 | — | — | 800 (120) | 189 | 2.54 |
| Example 2 | 250 | — | — | 800 (100) | 177 | 2.51 |
| Comparative | 250 | — | 800 (100) | — | 177 | 2.51 |
| Example 1 | | | | | | |
| Comparative | 250 | 80 | — | — | 884 | 2.68 |
| Example 3 | | | | | | |

TABLE 6
Evaluation results for liquids A for backfill pouring in shield
tunneling operations

| | Bleeding ratio | |
|---|---|---|
| | after 24 h (%) | Viscosity (dPas) |
| Example 1 | 0.5 | 1.2 |
| Example 2 | 0 | 1.5 |
| Comparative Example 1 | 50 | Measurements are |
| | | impossible |
| Comparative Example 3 | 2 | 11 |

As shown in Table 6, the bleeding ratio was very high in Comparative Example 1, and because material separation was remarkable, the viscosity could not be measured. In Comparative Example 3, the bleeding ratio was good, but the viscosity was high and the long-distance pumping ability was poor. In contrast, in Examples 1 and 2, both the bleeding ratio (standard <5%) and the viscosity demonstrated good values.

1. A method for manufacturing a concrete material from a slurry containing a fresh concrete sludge, the method comprising at least
a grinding step of obtaining a product containing fine particles having a mean particle diameter of 10 μm or less by wet grinding the slurry under a condition of water content of 60 wt. % or more.

2. The manufacturing method according to claim 1, wherein the water content is from 60 to 95 wt. %.

3. The manufacturing method according to claim 1, wherein the fine particles have a mean particle diameter of 1 μm or more but less than 10 μm.

4. The manufacturing method according to claim 1, the method further comprising, prior to the grinding step, a water content adjustment step of adjusting the water content of the slurry by taking out and dewatering part of the slurry and returning the dewatered remaining fraction into the slurry.

5. The manufacturing method according to claim 1, wherein the slurry is obtained by a method comprising
(1) a coarse aggregate separation step of separating a coarse aggregate from a fresh concrete waste;
(2) a fine aggregate separation step of separating a fine aggregate from the slurry obtained in the coarse aggregate separation step; and
(3) a fine aggregate very fine fraction separation step of separating a very fine fraction of the fine aggregate from the slurry obtained in the fine aggregate separation step.

6. A concrete material obtained by the manufacturing method according to claim 1.

7. A grout material containing cement and the concrete material according to claim 6.

8. An apparatus for manufacturing a concrete material from a fresh concrete sludge, comprising:
(1) coarse aggregate separation means for separating a coarse aggregate from a fresh concrete waste;
(2) fine aggregate separation means for separating a fine aggregate from the slurry obtained by performing the coarse aggregate separation treatment;
(3) water content adjustment means for adjusting a water content of the slurry by taking out and dewatering part of the slurry obtained by implementing the separation treatment of the coarse aggregate and fine aggregate, and returning the dewatered remaining fraction into the slurry; and
(4) grinding means for wet grinding the slurry with the water content thereof adjusted in the water content adjustment means.

9. The manufacturing apparatus according to claim 8, further comprising fine aggregate very fine fraction separation means for separating a very fine fraction of the fine aggregate from the slurry obtained in the fine aggregate separation means.
